(19) United States
(12) Patent Application Publication
(10) Pub. No.: US 2011/0054094 A1
(43) Pub. Date: Mar. 3, 2011

(54) COLOR PARTICLES

(75) Inventors: Kazumichi Nakahama, Tokyo (JP); Takayuki Hiratani, Tokyo (JP); Shoji Koike, Yokohama-shi (JP)

(73) Assignee: CANON KABUSHIKI KAISHA, Tokyo (JP)

(21) Appl. No.: 12/869,425

(22) Filed: Aug. 26, 2010

(30) Foreign Application Priority Data
Aug. 31, 2009 (JP) 2009-200240
Jun. 22, 2010 (JP) 2010-141943

(51) Int. Cl. C09D 11/10

(52) U.S. Cl. 524/186

(57) ABSTRACT

In color particles containing a dye and a polymer compound, the average particle diameter of the color particles measured by a dynamic light scattering method is 10 to 80 nm, the content of the dye of the color particles is in the range of 60 to 90 percent by mass, and the dye has a solubility index of 7.50 or more in water having a pH of 6.0 to 11.0, the solubility index being represented by the following equation (1): Solubility Index=log(1/Aqueous Solubility of Dye [mol/L]).

### BACKGROUND OF THE INVENTION

1. Field of the Invention

The present invention relates to color particles.

2. Description of the Related Art

When a recording image is formed by applying an ink containing color particles, such as a pigment, on a recording medium, if the color particles are finely pulverized particles, light scattering on the recording medium caused by the color particles can be suppressed. Hence, concomitant with an increase in content of the color particles of the ink, the image density of the recording image can be improved. In addition, fine color particles are easily filled in fine pores present in fibers of a recording medium or an ink receiving layer and have a physical interaction therewith. As a result, a scratch resistance of the recording image is improved.

As a method for forming the color particles as described above, for example, a method in which color particles containing a dye and a polymer compound are formed by emulsion polymerization or miniemulsion polymerization has been known. Japanese Patent Laid-Open No. 09-279073 has disclosed a method in which a dye is contained in emulsion polymerization, and when a monomer is converted into a polymer compound to form particles, the dye is incorporated in the particles. In addition, Japanese Patent Laid-Open 2001-302708 has disclosed a method in which water and an oil phase dissolving a dye are emulsified and are then processed by miniemulsion polymerization to form color particles.

### SUMMARY OF THE INVENTION

Aspects of the present invention provide color particles containing a dye and a polymer compound, the average particle diameter of the color particles measured by a dynamic light scattering method is 10 to 80 nm, the content of the dye of the color particles is 60 to 90 percent by mass, and the dye has a solubility index of 7.50 or more in water having a pH of 6.0 to 11.0, the solubility index being represented by the following equation (1).

Solubility Index=log(1/Aqueous Solubility of Dye [mol/L]) Equation (1)

Further features of the present invention will become apparent from the following description of exemplary embodiments with reference to the attached drawings.

### BRIEF DESCRIPTION OF THE DRAWINGS

FIG. 1 is a view showing a method for manufacturing color particles according to an aspect of the present invention.

FIG. 2 is a view showing a related method for manufacturing color particles.

### DESCRIPTION OF THE EMBODIMENTS

The color particles obtained, for example, by the methods disclosed in Japanese Patent Laid-Open Nos. 09-279073 and 2001-302708 have a low dye content, and when a recording image is formed using the color particles described above, there has been a problem in that a sufficiently high image density cannot be easily obtained.

In consideration of the above problem, aspects of the present invention provide finely pulverized color particles capable of forming a high density recording image.

Aspects of the present invention provide color particles containing a dye and a polymer compound, the average particle diameter of the color particles measured by a dynamic light scattering method is 10 to 80 nm, the content of the dye of the color particles is 60 to 90 percent by mass, and the dye has a solubility index of 7.50 or more in water having a pH of 6.0 to 11.0, the solubility index being represented by the following equation (1).

Solubility Index=log(1/Aqueous Solubility of Dye [mol/L]) Equation (1)

The color particles according to aspects of the present invention have an average particle diameter of 10 to 80 nm measured by a dynamic light scattering method, and the average particle diameter may be 50 nm or less. If the average particle diameter is in the range of 10 to 80 nm, when a recording image is formed on a recording medium, light scattering on the recording medium by the color particles is suppressed, and hence the image density can be improved. In addition, since the color particles described above have a physical interaction with fine pores in fibers of the recording medium or an ink receiving layer, the scratch resistance can be improved. On the other hand, if the average particle diameter is less than 10 nm, when a recording image is formed on a recording medium, light resistance and/or gas resistance tends to degrade. In addition, if the average particle diameter is more than 80 nm, when a recording image is formed on a recording medium, the image density tends to degrade due to light scattering and/or the scratch resistance tends to degrade. The average particle diameter of the color particles according to aspects of the present invention measured by a dynamic light scattering method is an average particle diameter in water, that is, a dispersed particle diameter which is obtained in such a way that the color particles are dispersed in water and are then measured by a dynamic light scattering method. As a particle diameter measurement apparatus using a dynamic light scattering method, for example, DLS8000 (manufactured by Otsuka Electronics Co., Ltd) may be mentioned.

In addition, according to aspects of the present invention, besides the average particle diameter measured by a dynamic light scattering method, which is the average particle diameter of color particles in water, an average particle diameter in a dry state is also defined. The average particle diameter in a dry state according to aspects of the present invention is a number average value obtained by measuring particle diameters of 1,000 color particles or more using an image formed by a scanning electron microscope (SEM) or a transmission electron microscope (TEM). However, another method other than that described above may also be used when the value of the average particle diameter in a dry state according to aspects of the present invention is not changed. According to aspects of the present invention, the dry state indicates the state in which by a related known method, such as natural drying or vacuum freeze drying, at least 99 percent by mass of a liquid is removed from the color particles.

According to aspects of the present invention, a coefficient of variation of the average particle diameter of the color particles measured by a dynamic light scattering method may be 60% or less, such as 50% or less, and even such as 40% or less. When the coefficient of variation is more than 60%, in the case of an aqueous ink, dispersion stability thereof degrades, and as a result, storage stability and/or ejection stability may degrade in some cases. In addition, if the coefficient of variation is more than 60%, when an image is formed on a recording medium, a filling rate into fine pores of fibers of the recording medium or an ink receiving layer may be decreased, and/or an interaction therewith is not likely to occur, so that the scratch resistance tends to degrade. In addition, a particle diameter distribution of an aqueous dispersion containing the color particles according to aspects of the present invention may be a single peak distribution.

The coefficient of variation of the average particle diameter of the color particles according to aspects of the present invention is calculated by the following equation (2) using the average particle diameter of the color particles measured by a dynamic light scattering method and the standard deviation of the particle diameters.

Coefficient of Variation=((Standard deviation of Particle Diameters of Color Particles)/(Average Particle Diameter of Color Particles))×100 Equation (2)

According to aspects of the present invention, the content of the dye of the color particles is 60 to 90 percent by mass. If the content of the dye is less than 60 percent by mass, when an image is formed on a recording medium, the image density tends to degrade. On the other hand, if the content is more than 90 percent by mass, the content of the polymer compound of the color particles becomes insufficient, and as result, the durability and the shape stability tend to degrade.

According to aspects of the present invention, within the range in which the total of the content of the polymer compound and that of the dye is not more than 100 percent by mass, the content of the polymer compound of the color particles may be in the range of 10 to 40 percent by mass. The polymer compound in the color particles functions as a binding agent for the dye. When the content of the polymer compound is more than 40 percent by mass, the content of the dye in the color particles is decreased, and when a recording image is formed, the image density tends to degrade. When the content of the polymer compound is less than 10 percent by mass, the durability and the shape stability tend to degrade.

Heretofore, in color particles manufactured by emulsion polymerization, miniemulsion polymerization, or the like, a polymer compound is also contained as a binding agent. However, unless the polymer compound is contained at a high concentration, a sufficient effect as the binding agent cannot be easily obtained. The reason for this is believed to be that by a related known manufacturing method, the dye is liable to be localized in the color particles.

On the other hand, since the color particles according to aspects of the present invention can uniformly incorporate the dye, it is believed that even when the content of the polymer compound is in the range of 10 to 40 percent by mass, the effect as the binding agent can be sufficiently obtained. In addition, in the color particles according to aspects of the present invention, when the contents of the polymer compound and the dye are satisfied as described above, an ultraviolet absorber, a binding agent other than the polymer compound, an antiseptic, and other additives may also be contained as auxiliary agents.

The color particles according to aspects of the present invention may have an average aspect ratio of 1.0 to 1.2 so as to increase the sphericity. The average aspect ratio of the color particles according to aspects of the present invention is obtained in such a way that after values of “long diameter/short diameter” of 1,000 color particles are measured and calculated, the number average value is obtained from the averages thereof. Since the color particles as described above have superior fluidity when being used for an aqueous ink, superior ejection properties can be advantageously obtained.

In the color particles according to aspects of the present invention, the ratio of the average particle diameter (average particle diameter measured by a dynamic light scattering method) in water to the average particle diameter in a dry state, that is, (average particle diameter in water)/(average particle diameter in a dry state), may be set to 1.2 or less. The reason for this is to decrease the degree of swelling of the color particles in an aqueous ink and to suppress degradation of the durability and the shape stability even when environmental changes, such as changes in pH and/or temperature, occurs. When this ratio is more than 1.2, stability against environmental changes, such as the change before and after ejection of an aqueous ink, may not be sufficient in some cases.

The dye of the color particles according to aspects of the present invention has a solubility index of 7.50 or more in water having a pH of 6.0 to 11.0, the solubility index being represented by the equation (1). As for the solubility index represented by the equation (1), a lower value indicates a higher aqueous solubility of the dye, and a higher value indicates a lower aqueous solubility thereof. According to aspects of the present invention, in order to obtain a miniemulsion, water and a mixed liquid containing a dye are emulsified. In addition, in order to obtain fine color particles having superior monodispersibility according to aspects of the present invention, the solubility of the dye must be low in this water. The inventors of the present invention discovered that when the solubility index is less than 7.50, it can be difficult to stably form the color particles. The reason for this is believed to be that when the solubility index is less than 7.50, the dye is dissolved in water although its amount is very small, and thereby the dispersion stability of the color particles may be adversely influenced.

The solubility index of the dye may change depending on the pH of water in some cases. Hence, by a related method, the pH of water may be set so that the solubility index of the dye is 7.50 or more. However, the pH of water in ink composition preparation is at most in the range of 6.0 to 11.0. Accordingly, in water having a pH of 6.0 to 11.0, when the solubility index of the dye is 7.50 or more, the color particles can be stably formed.

The solubility index according to aspects of the present invention can be calculated in such a way that after the solubility of the dye in water is measured by a related known experimental method, the value thus obtained is substituted into the equation (1). The solubility index according to aspects of the present invention may be calculated by substituting the solubility (mol/L) of the dye in water calculated by ACD/Structure Design Suite (manufacturing by Fujitsu Ltd.) into the equation (1). As a matter of course, the solubility in the equation (1) is the solubility in water having a pH of 6.0 to 11.0. The inventors of the present invention confirmed that the solubility index thus calculated well coincides with the experimental result. In addition, in the case of a metal complex dye, a salt-forming dye, or the like, it may be the case that after a metal or a salt is removed, the solubility is calculated by ACD/Structure Design Suite, and the solubility index is then calculated using the solubility thus obtained.

When the above conditions are satisfied, the dyes according to aspects of the present invention may also include, for example, at least one of a disperse dye, a metal complex dye, and a dye having oil solubility by forming a salt between a water-soluble dye and a long chain base, such as a salt-forming dye derived from an acidic dye, a direct dye, and a reactive dye with a long chain amine.

The polymer compound included in the color particles according to aspects of the present invention may be, for example, a polymer compound containing a polymer of a polymerizable unsaturated aromatic material or a polymer of a polymerizable carboxylic acid ester. These polymer compounds may have good characteristics in terms of the affinity to the dye, the durability in water, and the like. Furthermore, in terms of the dispersion stability in water, a polymer compound containing a copolymer between a polymerizable carboxylic acid and a polymerizable unsaturated aromatic material or a copolymer between a polymerizable carboxylic acid and a polymerizable carboxylic acid ester may be provided. As the polymer of a polymerizable unsaturated aromatic material, for example, a polystyrene, a polychlorostyrene, a poly(α-methylstyrene), a poly(divinylbenzene), and a poly(vinyl toluene) may be mentioned. As the polymer of a polymerizable carboxylic acid ester, for example, a poly(methyl (meth)acrylate), a poly(ethyl(meth)acrylate), a poly(n-butyl (meth)acrylate), a poly(2-hydroxyethyl (meth) acrylate), a poly(glycidyl (meth)acrylate), a poly(ethylene glycol di(meth)acrylate), and a poly(tribromophenyl (meth)acrylate) may be mentioned. As the polymer of a polymerizable carboxylic acid, for example, a poly((meth)acrylic acid), a poly(itaconic acid), a poly(maleic acid), and a poly(fumaric acid) may be mentioned. The polymer compound may have a weight average molecular weight of 10,000 to 10,000,000.

Next, a method for manufacturing color particles according to aspects of the present invention will be described. The method for manufacturing color particles according to aspects of the present invention includes an emulsification step of emulsifying water and a mixed liquid containing an organic solvent, a monomer, and a dye to obtain a miniemulsion which has dispersoids containing the mixed liquid, a removal step of removing the organic solvent from the dispersoids, and a polymerization step of polymerizing the monomer after the removal step is performed. The solubility index of the dye represented by the following equation (1) is 7.50 or more in water having a pH of 6.0 to 11.0.

Solubility Index=log(1/Aqueous Solubility of Dye [mol/L]) Equation (1)

The method for manufacturing color particles according to aspects of the present invention will be described with reference to related miniemulsion polymerization for the purpose of comparison.

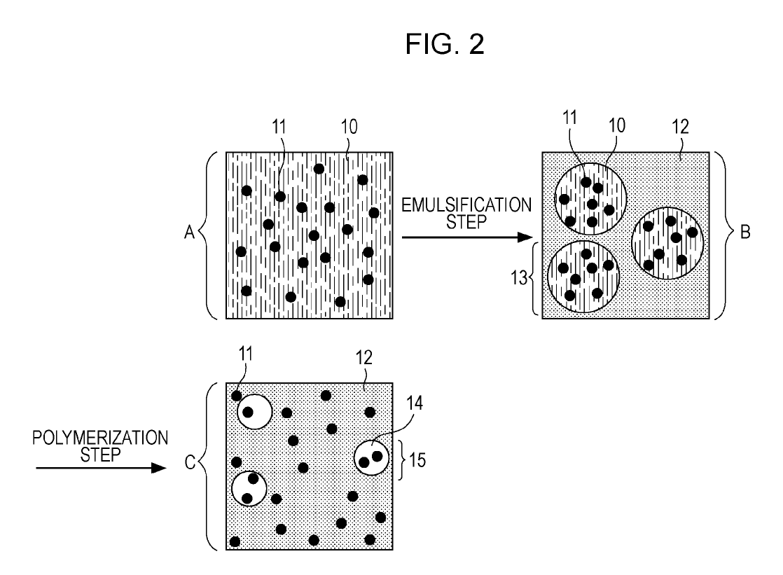

In the related miniemulsion polymerization, color particles are manufactured by a method shown in FIG. 2. In FIG. 2, a mixed liquid A contains a monomer 10 and a dye 11. Next, the mixed liquid A and water 12 are mixed together for emulsification to form an O/W type emulsion B containing dispersoids 13. Subsequently, the monomer 10 in the dispersoids 13 is converted into a polymer compound 14 by polymerization to obtain a dispersion C containing color particles 15.

The inventors of the present invention found that in the related miniemulsion polymerization as described above, it is difficult to increase the content of the dye 11 in the color particles 15. It is believed that this difficulty is caused by two problems of the miniemulsion polymerization.

The first problem is that the concentration of the dye 11 in the mixed liquid A cannot be easily increased to a certain level or more. When the concentration of the dye 11 is increased, since the viscosity of the mixed liquid A is increased, an emulsification step typically cannot be performed. As a result, the monodispersibility of the color particles 15 is liable to degrade. In addition, the content of the dye 11 in the color particles 15 tends to be non-uniform. Furthermore, the color particles 15 agglomerate with each other, and as a result, coarse agglomerated clusters may be formed in some cases.

The second problem is that when the monomer 10 is converted into the polymer compound 14 in a polymerization step, a large volume contraction of the dispersoids 13 rapidly occurs. By this contraction, the dye 11 is liable to be separated from the dispersoids 13, and as a result, the content of the dye 11 in the color particles 15 is remarkably decreased.

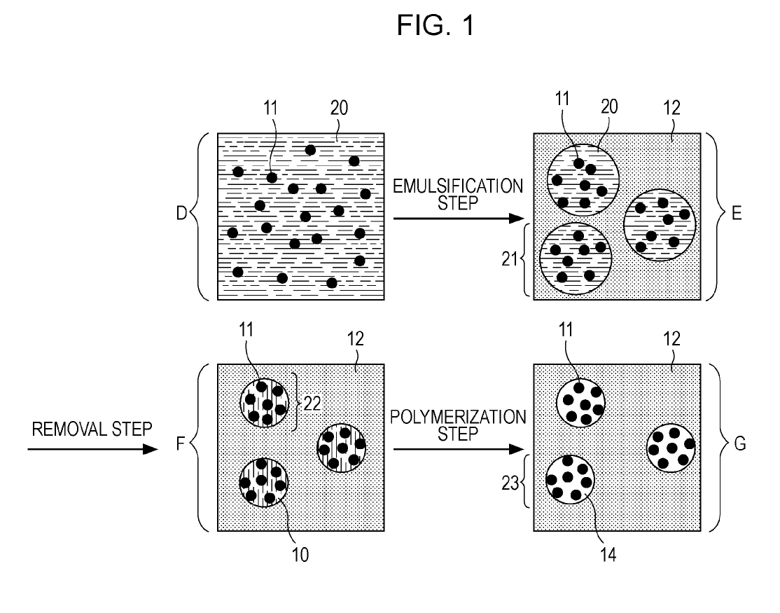

On the other hand, in the manufacturing method according to aspects of the present invention, the color particles are formed by a process shown in FIG. 1. In FIG. 1, a mixed liquid D is a mixture of the dye 11 and a first liquid 20 containing an organic solvent (not shown) and the monomer 10 (not shown). Next, the water 12 and the mixed liquid D are emulsified by an emulsification step to obtain a miniemulsion E which contains a mixed liquid in the form of dispersoids 21. The dispersoids 21 each contain the mixed liquid D. Next, the organic solvent is removed from the dispersoids 21 by a removal step to form an emulsion F containing dispersoids 22. Furthermore, after the removal step is performed, by a polymerization step performed to polymerize the monomer 10 in the dispersoids 22, the monomer 10 is converted into the polymer compound 14, so that a dispersion G containing color particles 23 is obtained. For example, whenever necessary, the dispersion G may be added with an organic solvent and/or may be processed to control its surface tension so as to be used as an ink composition.

According to aspects of the manufacturing method of the present invention, the above two problems of the related miniemulsion polymerization can be overcome through the step of forming the emulsion F shown in FIG. 1, and the content of the dye in the color particles can be increased. The reasons for this are believed to be as follows.

The reason the first problem is overcome is believed to be that the mixed liquid D contains the first liquid 20 composed of the monomer 10 and the organic solvent. That is, when only the ratio between the monomer 10 and the organic solvent is changed, without increasing the viscosity of the mixed liquid D, the content ratio of the monomer 10 to the dye 11 can be decreased, and emulsification can be performed.

The reason the second problem is overcome is believed to be as follows. Since the organic solvent is removed in the removal step, the dispersoids 22 in FIG. 1 each contain the dye 11 at a significantly high concentration. That is, the relationship between the monomer 10 and the dye 11 in the dispersoid 22 shown in FIG. 1 is different from that in the dispersoid 13 shown in FIG. 2 in which the dye 11 is dissolved or dispersed in the monomer 10, and as shown in FIG. 1, the state is formed as if the monomer 10 is incorporated in the dye 11. Since the mobility of the dye 11 is suppressed in the dispersoid 22, it is believed that even when the monomer 10 is converted into the polymer compound 14 in the polymerization step, the dye 11 is not easily separated from the dispersoids 22.

As described above, as the features of the manufacturing method according to aspects of the present invention, the emulsion F is intentionally formed as an intermediate state in the removal step of removing the organic solvent from the dispersoids, and after this removal step, the monomer is polymerized. That is, according to one aspect, it is essential that “after the removal step”, the monomer is polymerized. Accordingly, the content of the dye in the color particles can be significantly increased, and hence the monodispersibility can be improved.

The emulsion according to aspects of the present invention includes a mixed liquid containing a monomer, an organic solvent, and a dye in the form of dispersoids. The average particle diameter of the dispersoids may be 10 to less than 1,000 nm. Since the monodispersibility of the color particles which are the target product can be significantly improved, it may be the case that the dispersoids practically have a single peak particle diameter distribution. When the average particle diameter of the dispersoids of the emulsion is 1,000 nm or more, monodispersible color particles having a small particle diameter and a high dye content cannot be easily obtained. The average particle diameter of the dispersoids according to aspects of the present invention is the value measured by a dynamic light scattering method. As a particle diameter measurement apparatus using a dynamic light scattering method, for example, DLS8000 (manufactured by Otsuka Electronics Co., Ltd) may be mentioned.

According to aspects of the present invention, a hydrophobe (hydrophobic material) soluble in the first liquid (solubility of 3.0 percent by mass or more at least at ordinary temperature (20° C.)) and having a solubility of 0.01 g/L or less in an aqueous solvent may be contained in the first liquid. Accordingly, the emulsion can be easily stabilized. As particular examples of the hydrophobe, for example, there may be mentioned straight, branched, and cyclic alkanes having 8 to 30 carbon atoms, such as hexadecane, squalane, and cyclooctane; alkyl acrylates having 8 to 30 carbon atoms, such as stearyl methacrylate and dodecyl methacrylate; alkyl alcohols having 8 to 30 carbon atoms, such as cetyl alcohol; alkyl thiols having 8 to 30 carbon atoms, such as decyl mercaptan; polymers, such as a polyurethane, a polyester, and a polystyrene; long aliphatic or aromatic carboxylic acids; esters of long aliphatic or aromatic carboxylic acids; long aliphatic or aromatic amines; ketones; halogenated alkanes; silanes; siloxanes; and isocyanates. For example, among those mentioned above, alkanes having 12 carbon atoms or more may be provided. In addition, alkanes having 20 carbon atoms or less may be provided.

According to aspects of the present invention, in order to stabilize the emulsion, a surfactant may be added as a dispersing agent to at least one of the first liquid and water. As the surfactant, any related known surfactants may be used as long as aspects of the present invention can be carried out.

In the emulsification step according to aspects of the present invention, for example, there may be used a related known emulsification method based on mechanical energy application using a high shear homomixer, an ultrasonic homogenizer, a high pressure homogenizer, or a thin film rotative and high speed mixer. For the purpose of forming a miniemulsion in the emulsification step, an ultrasonic homogenizer, a high pressure homogenizer, or a thin film rotative and high speed mixer may be used. In addition, the miniemulsion according to aspects of the present invention may also be obtained by membrane emulsification using an SPG membrane or by an emulsification method based on an interface chemical mechanism using a microreactor of a microchannel emulsification method or a branching microchannel emulsification method. These methods described above may be used alone or in combination. In addition, the miniemulsion according to aspects of the present invention may be prepared by one-stage emulsification or by multistage emulsification.

According to aspects of the present invention, the organic solvent contained in the first liquid may be an organic solvent which has a low solubility in water and which forms a practical interface when being mixed with water. In particular, when the solubility of the organic solvent in water is 3.0 percent by mass or less at ordinary temperature (20° C.), it may be the case since the miniemulsion is advantageously formed in the emulsification step. In addition, the organic solvent may be an organic solvent which has compatibility with the monomer and which dissolves 1.0 percent by mass or more of the dye at ordinary temperature. As the organic solvent described above, for example, there may be mentioned halogenated hydrocarbon (dichloromethane, chloroform, chloroethane, dichloroethane, trichloroethane, carbon tetrachloride, and the like); ketones (acetone, methyl ethyl ketone, methyl isobutyl ketone, and the like); ethers (tetrahydrofuran, ethyl ether, isobutyl ether, and the like); esters (ethyl acetate, butyl acetate, and the like); and aromatic hydrocarbons (benzene, toluene, xylene, and the like). According to aspects of the present invention, although the first liquid contains the organic solvent, in order to dissolve the dye, 50.0 percent by mass or more of the organic solvent may be contained. Although the upper limit is not particularly defined, in order to contain the monomer, the content may be 99.9 percent by mass or less.

As the monomer according to aspects of the present invention, any monomer may be used as long as aspects of the present invention can be carried out. In particular, a monomer having a polymerizable ethylenic unsaturated bond may be provided. In addition, a radical-polymerizable monomer may be provided. A polymerizable unsaturated aromatic material and a polymerizable carboxylic acid ester may be provided since they are advantageous in terms of compatibility with an organic solvent, stability of emulsion, controllability of polymerization reaction, and the like. In addition, in order to improve the dispersion stability of color particles, a polymerizable unsaturated aromatic material and a polymerizable carboxylic acid, or a polymerizable carboxylic acid ester and a polymerizable carboxylic acid may also be used at an appropriate mixing ratio.

As the polymerizable unsaturated aromatic material, for example, there may be mentioned styrene, chlorostyrene, α-methylstyrene, divinylbenzene, and vinyl toluene. As the polymerizable carboxylic acid ester, for example, there may be mentioned methyl (meth)acrylate, ethyl (meth)acrylate, n-butyl methyl (meth)acrylate, 2-hydroxyethyl (meth)acrylate, glycidyl (meth)acrylate, ethylene glycol di(meth)acrylate, and tribromophenyl (meth)acrylate. As the polymerizable carboxylic acid, for example, (meth)acrylic acid, itaconic acid, maleic acid, and fumaric acid may be mentioned.

The removal step according to aspects of the present invention indicates an operation extracting the organic solvent from the dispersoids of the emulsion. In this removal step, the degree of extraction of the organic solvent may be appropriately changed as long as aspects of the present invention can be carried out; however, in this step, at least 70.0 percent by mass of the organic solvent may be removed.

To the extraction operation in this removal step, any related known methods may be applied; however, in view of the throughput, a reduced-pressure operation, a dialysis operation, or a combination therebetween may be used. When the reduced-pressure operation is used, the organic solvent may be a volatile organic solvent. In addition, a monomer having a boiling point higher than that of the organic solvent may be used since the organic solvent can be preferentially extracted from the dispersoids of the emulsion. For the reduced-pressure operation, for example, a related known reduced-pressure device, such as an evaporator, may be used. When the dialysis operation is used, an organic solvent having a higher partition coefficient to water than that of the monomer may be provided since the organic solvent is preferentially extracted from the dispersoids of the emulsion. For the dialysis operation, for example, a related known dialysis device, such as an ultrafiltration device, may be used.

As the polymerization initiator used in the polymerization step according to aspects of the present invention, for example, the following polymerization initiators may be mentioned. As azo(azobisnitrile) type initiators, for example, there may be mentioned 2,2′-azobisisobutyronitrile, 2,2′-azobis-(2-methylpropanenitrile), 2,2′-azobis-(2,4-dimethylpentanenitrile), 2,2′-azobis-(2-methylbutanenitrile), 1,1′-azobis-(cyclohexanecarbonitrile), 2,2′-azobis(2,4-dimethyl-4-methoxyvaleronitrile), 2,2′-azobis(2,4-dimethylvaleronitrile), and 3,2′-azobis(2-amidinopropane)hydrochloride. As peroxide type initiators, for example, there may be mentioned benzoyl peroxide, cumenehydroperoxide, hydrogen peroxide, acetyl peroxide, lauroyl peroxide, persulfates (such as ammonium persulfate), and peracid esters (such as t-butyl peroctate, α-cumylperoxypivalate, and t-butyl peroctate). In addition, as the initiators, for example, there may be mentioned ascorbic acid/iron (II) sulfate/sodium peroxydisulfate, tertiary-butyl hydroperoxide/sodium disulfite, and tertiary-butyl hydroperoxide/sodium hydroxymethane sulfinic acid.

The polymerization initiator may be added to at least one of the first liquid and water before the emulsification step or may be added to the emulsion after the emulsification step. When being added to the emulsion, the polymerization initiator may be added either before or after the removal step of removing the organic solvent.

According to aspects of the present invention, the dispersion containing the color particles is adjusted using water and/or an organic solvent which has been generally used, so that an ink composition can be obtained. In addition, the ink composition according to aspects of the present invention may be used as an ink for ink jet recording purpose.

### EXAMPLES

Hereinafter, examples of the color particles according to aspects of the present invention and the manufacturing method thereof will be described; however, the present invention is not limited to the examples.

### Example 1

After 5.0 g of Solvent Blue 35 (dye) was dissolved in 97.5 g of chloroform, 2.5 g of methyl methacrylate was further added to form a mixed liquid. Next, the mixed liquid was added to 400 g of water (containing 6.0 g of dodecyl sodium sulfate, pH: 11.0). Furthermore, an emulsification treatment was performed for 20 minutes at 4° C. by an ultrasonic homogenizer, so that an emulsion was obtained. The solubility index of Solvent Blue 35 in water having a pH of 11.0 was 8.16. In addition, the solubility index of Solvent Blue 35 in water having a pH of 6.0 to 11.0 was also 7.50 or more. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 620 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, methyl methacrylate was polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 45 nm, and the coefficient of variation was 55%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 43 nm, and the average aspect ratio was 1.10. In the color particles thus obtained, the average particle diameter in water/the average particle diameter in a dry state was 1.05.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 35 prepared to have a predetermined concentration. As a result, the color particles contained 68 percent by mass of Solvent Blue 35 and 32 percent by mass of a polymer compound.

### Example 2

After 5.0 g of Solvent Blue 35 (dye) was dissolved in 97.5 g of chloroform, 2.0 g of methyl methacrylate and 0.5 g of methacrylic acid were further added to form a mixed liquid. Next, the mixed liquid was added to 400 g of water (containing 6.0 g of dodecyl sodium sulfate, pH: 11.0). Furthermore, an emulsification treatment was performed for 20 minutes at 4° C. by an ultrasonic homogenizer, so that an emulsion was obtained. The solubility index of Solvent Blue 35 in water having a pH of 11.0 was 8.16. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 582 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, methyl methacrylate and methacrylic acid were polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 42 nm, and the coefficient of variation was 42%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 37 nm, and the average aspect ratio was 1.05. In the color particles thus obtained, the average particle diameter in water/the average particle diameter in a dry state was 1.13.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 35 prepared to have a predetermined concentration. As a result, the color particles contained 62 percent by mass of Solvent Blue 35 and 38 percent by mass of a polymer compound.

### Example 3

After 5.0 g of Solvent Blue 97 (dye) was dissolved in 99.0 g of chloroform, 1.0 g of styrene was further added to form a mixed liquid. Next, after the mixed liquid was added to 400 g of water (containing 6.0 g of dodecyl sodium sulfate, pH: 11.0), an emulsification treatment was performed for 20 minutes at 4° C. by an ultrasonic homogenizer, so that an emulsion was obtained. The solubility index of Solvent Blue 97 in water having a pH of 11.0 was 12.06. In addition, the solubility index of Solvent Blue 97 in water having a pH of 6.0 to 11.0 was also 7.50 or more. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 660 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, styrene was polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 48 nm, and the coefficient of variation was 58%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 46 nm, and the average aspect ratio was 1.12. In the color particles thus obtained, the average particle diameter in water/the average particle diameter in a dry state was 1.04.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 97 prepared to have a predetermined concentration. As a result, the color particles contained 83 percent by mass of Solvent Blue 97 and 17 percent by mass of a polymer compound.

### Example 4

After 5.0 g of Solvent Blue 35 (dye) was dissolved in 97.5 g of chloroform, 2.0 g of styrene and 0.5 g of methacrylic acid were further added to form a mixed liquid. Next, the mixed liquid was added to 400 g of water (containing 6.0 g of dodecyl sodium sulfate, pH: 11.0). Furthermore, an emulsification treatment was performed for 20 minutes at 4° C. by an ultrasonic homogenizer, so that an emulsion was obtained. The solubility index of Solvent Blue 35 in water having a pH of 11.0 was 8.16. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 487 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, styrene and methacrylic acid were polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 38 nm, and the coefficient of variation was 35%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 33 nm, and the average aspect ratio was 1.07. In the color particles thus obtained, the average particle diameter in water/the average particle diameter in a dry state was 1.15.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 35 prepared to have a predetermined concentration. As a result, the color particles contained 67 percent by mass of Solvent Blue 35 and 33 percent by mass of a polymer compound.

### Example 5

After 5.0 g of Solvent Blue 97 (dye) was dissolved in 99.0 g of chloroform, 1.0 g of styrene was further added to form a mixed liquid. Next, the mixed liquid was added to 400 g of water (containing 2.4 g of dodecyl sodium sulfate, pH: 11.0). Furthermore, an emulsification treatment was performed for 20 minutes at 4° C. by an ultrasonic homogenizer, so that an emulsion was obtained. The solubility index of Solvent Blue 97 in water having a pH of 11.0 was 12.06. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 830 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, styrene was polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 78 nm, and the coefficient of variation was 52%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 74 nm, and the average aspect ratio was 1.12. In the color particles thus obtained, the average particle diameter in water/the average particle diameter in a dry state was 1.06.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 97 prepared to have a predetermined concentration. As a result, the color particles contained 79 percent by mass of Solvent Blue 97 and 21 percent by mass of a polymer compound.

### Example 6

After 5.0 g of the following compound 1 (dye) was dissolved in 99.0 g of chloroform, 1.0 g of styrene was further added to form a mixed liquid. Next, the mixed liquid was added to 400 g of water (containing 4.8 g of dodecyl sodium sulfate, pH: 11.0). Furthermore, an emulsification treatment was performed for 20 minutes at 4° C. by an ultrasonic homogenizer, so that an emulsion was obtained. The solubility index of the compound 1 in water having a pH of 11.0 was 7.84. In addition, the solubility index of the compound 1 in water having a pH of 6.0 to 11.0 was also 7.50 or more. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 760 nm.

Subsequently, chloroform was removed from the emulsion using an evaporator under reduced pressure, and the pressure reduction and pressurization by nitrogen introduction were repeated five times. Next, after 0.1 g of KPS (potassium persulfate) functioning as the initiator was added, and the temperature was increased, styrene was polymerized at 70° C. for 8 hours, so that color particles were obtained. After being purified by dialysis, the color particles were re-dispersed in distilled water, thereby forming an aqueous dispersion of the color particles.

By the measurement of the color particles in the aqueous dispersion using DLS8000 (manufactured by Otsuka Electronics Co., Ltd), it was found that the particle diameter distribution had a single peak, the average particle diameter was 49 nm, and the coefficient of variation was 58%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 45 nm, and the average aspect ratio was 1.09. In the color particles thus obtained, the average particle diameter in water/the average particle diameter in a dry state was 1.08.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of the compound 1 prepared to have a predetermined concentration. As a result, the color particles contained 81 percent by mass of the compound 1 and 19 percent by mass of a polymer compound.

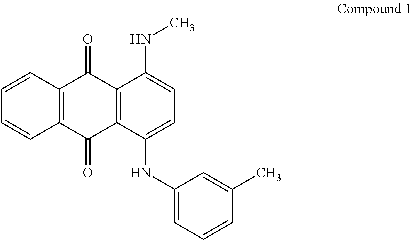

### Comparative Example 1

After 5.0 g of Solvent Blue 36 (dye) was dissolved in 99.0 g of chloroform, 1.0 g of styrene was further added to form a mixed liquid. Next, the mixed liquid was added to 400 g of water (containing 6.0 g of dodecyl sodium sulfate, pH: 8.0). Furthermore, an emulsification treatment was performed for 20 minutes at 4° C. by an ultrasonic homogenizer, so that an emulsion was obtained. The solubility index of Solvent Blue 36 in water having a pH of 8.0 was 7.37. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 750 nm.

Next, when the step of removing chloroform from the emulsion was tried using an evaporator under reduced pressure, the dispersion system of the emulsion was destroyed, and agglomeration occurred, so that color particles could not be dispersed.

### Comparative Example 2

After 5.0 g of the following compound 2 (dye) was dissolved in 99.0 g of chloroform, 1.0 g of styrene was further added to form a mixed liquid. Next, the mixed liquid was added to 400 g of water (containing 6.0 g of dodecyl sodium sulfate, pH: 8.0). Furthermore, an emulsification treatment was performed for 20 minutes at 4° C. by an ultrasonic homogenizer, so that an emulsion was obtained. The solubility index of the compound 2 in water having a pH of 8.0 was 7.30. By the measurement of this emulsion using DLS8000 (manufactured by Otsuka Electronics Co., Ltd), it was found that this emulsion was a miniemulsion which had a single peak particle diameter distribution and which contained dispersoids of an average particle diameter of 730 nm.

Next, when the step of removing chloroform from the emulsion using an evaporator under reduced pressure was tried, the dispersion system of the emulsion was destroyed, and agglomeration occurred, so that color particles could not be dispersed. The reason the agglomeration occurred as described above is believed that since the compound 2 solved out from the dispersoids of the emulsion although the amount of the compound 2 was very small, the dispersion stability of the emulsion was seriously degraded.

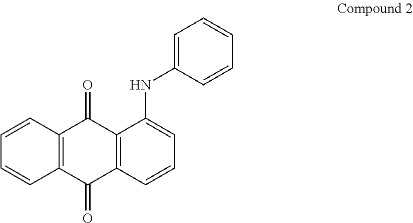

### Comparative Example 3

In this comparative example, as described below, by an emulsion polymerization technique of a related art, it was intended to manufacture monodispersible color particles having a small particle diameter and containing a dye at a high concentration.

First, after 6.0 g of Solvent Blue 35 was dispersed in 100 g of distilled water, 4.0 g of styrene was further added, so that a reaction solution was formed. After the reaction solution was heated to 70° C. while being bubbled with nitrogen, emulsion polymerization was tried by adding 0.05 g of KPS (potassium persulfate) functioning as the initiator; however, coarse agglomerates were generated, and a material in the form of particles could not be manufactured.

### Comparative Example 4

In this comparative example, as described below, by a miniemulsion polymerization technique of a related art, it was intended to manufacture monodispersible color particles having a small particle diameter and containing a dye at high concentration.

First, after 6.0 g of Solvent Blue 35 and 4.0 g of styrene were mixed together to form a slurry, the slurry was mixed with 40.0 g of an aqueous dodecyl sodium sulfate solution (15.0 g/L) by an ultrasonic homogenizer for 20 minutes at 4° C. as an emulsification treatment. Subsequently, the emulsion thus obtained was heated to 70° C. while being bubbled with nitrogen, and miniemulsion polymerization was tried by adding 0.1 g of KPS (potassium persulfate) functioning as the initiator; however, agglomerates were generated. Since some color particles in a dispersed state were partially obtained, the average particle diameter thereof in water was evaluated by DLS8000 (manufactured by Otsuka Electronics Co., Ltd), and it was found that the particle diameter distribution had a plurality of peaks. In addition, it was also confirmed that most average particle diameters associated with the respective peaks were large values on the order of submicrometers or more.

### Comparative Example 5

A solution was obtained by dissolving 5.0 g of Solvent Blue 35 (dye) in 7.0 g of styrene. Next, the solution thus obtained was added to 50 g of water (containing 1.0 g of dodecyl sodium sulfate, pH: 11.0). Furthermore, an emulsification treatment was performed for 10 minutes at 4° C. by an ultrasonic homogenizer, so that an emulsion was obtained. Next, after being bubbled with nitrogen, the emulsion was added with 0.3 g of KPS (potassium persulfate) functioning as the initiator and was then heated, and styrene was polymerized at 70° C. for 8 hours, so that color particles were obtained. After being purified by dialysis, the color particles were re-dispersed in distilled water to form an aqueous dispersion of the color particles. The solubility index of Solvent Blue 35 in water having a pH of 11.0 was 8.16.

By the measurement of the color particles in the aqueous dispersion using DLS8000 (manufactured by Otsuka Electronics Co., Ltd), it was found that the particle diameter distribution had a single peak, the average particle diameter was 78 nm, and the coefficient of variation was 59%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found that the average particle diameter was 73 nm, and the average aspect ratio was 1.10. In the color particles thus obtained, the average particle diameter in water/the average particle diameter in a dry state was 1.07.

After the color particles were solidified by freeze drying of the aqueous dispersion and were then dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 35 prepared to have a predetermined concentration. As a result, the color particles contained 36 percent by mass of Solvent Blue 35 and 64 percent by mass of a polymer compound.

### Comparative Example 6

In this example, 5.0 g of styrene and 5.0 g of Solvent Blue 97 (dye) were dissolved in 50 g of chloroform to form a solution. Next, the solution was added to 150 g of water (containing 0.75 g of dodecyl sodium sulfate, pH: 11.0). Furthermore, an emulsification treatment was performed for 10 minutes at 4° C. by an ultrasonic homogenize, so that an emulsion was obtained. Next, after being bubbled with nitrogen, the emulsion was added with 0.1 g of KPS (potassium persulfate) functioning as the initiator and was then heated, and styrene was polymerized at 70° C. for 8 hours, so that a mixture of a dispersed material and agglomerates was obtained. Accordingly, the agglomerates were removed by filtration using a filter and centrifugal separation to isolate only the dispersed material, so that color particles were obtained. After being purified by dialysis, the color particles were re-dispersed in distilled water to form an aqueous dispersion of the color particles. The solubility index of Solvent Blue 97 in water having a pH of 11.0 was 12.06.

By the measurement of the color particles in the aqueous dispersion using DLS8000 (manufactured by Otsuka Electronics Co., Ltd), it was found that the particle diameter distribution had a single peak, the average particle diameter was 94 nm, and the coefficient of variation was 57%. In addition, the aqueous dispersion of the color particles was dripped on a collodion film supported by a copper mesh for TEM observation and was spontaneously dried for 10 hours or more, so that the color particles in a dry state were prepared. By the measurement of the average particle diameter of the color particles in a dry state performed as described above, it was found the average particle diameter was 89 nm, and the average aspect ratio was 1.13. In the color particles thus obtained, the average particle diameter in water/the average particle diameter in a dry state was 1.06.

After the color particles were solidified by freeze drying of the aqueous dispersion and were then further dissolved in chloroform, a maximum absorption wavelength and an optical absorption intensity thereof were evaluated by absorbance measurement. In particular, the optical absorption intensity was compared with a calibration curve obtained by absorbance measurement of a chloroform solution of Solvent Blue 97 prepared to have a predetermined concentration. As a result, the color particles contained 51 percent by mass of Solvent Blue 97 and 49 percent by mass of a polymer compound.

### Image Density

The color particles of Example 1 were added to an aqueous solution containing water and glycerin, so that an ink composition 1 containing 5.0 percent by mass of the color particles and 10.0 percent by mass of glycerin was prepared.

In addition, the color particles of Comparative Example 5 were added to an aqueous solution containing water and glycerin, so that an ink composition 2 containing 5.0 percent by mass of the color particles and 10.0 percent by mass of glycerin was prepared.

Recording images were formed using the ink compositions 1 and 2 on recording media (Office Planer, manufactured by CANON KABUSHIKI KAISHA) by a piezoelectric type ink jet printer (PX-V630, manufactured by Seiko Epson Corp.) and were evaluated by visual inspection. As a result, it was confirmed that compared to the recording image formed using the ink composition 2, the recording image formed using the ink composition 1 was apparently clear and had a high image density.

### Scratch Resistance

The color particles of Example 3, Example 5, and Comparative Example 6 were added to respective aqueous solutions each containing water and glycerin so as to form ink compositions 3, 4, and 5, respectively, each containing 5.0 percent by mass of the color particles and 20.0 percent by mass of glycerin.

Recording images were formed using the ink compositions 3, 4, and 5 on recording media (Office Planer, manufactured by CANON KABUSHIKI KAISHA) by a piezoelectric type ink jet printer (PX-V630, manufactured by Seiko Epson Corp.). The recording image was rubbed with a fingertip one minute and one hour after the formation thereof at a load of approximately 500 g. A scratch resistance test was performed as described above, and the results were evaluated based on the following criteria.

A: No ink blur is observed on the recording image one minute and one hour after its formation.

B: Although no ink blur is observed on the recording image one hour after its formation, an ink blur is slightly observed on the recording image one minute after its formation.

C: An ink blur is observed on the recording image both one minute and one hour after its formation.

The results are shown in Table 1.

TABLE 1

| | Average Particle Diameter | | Scratch |
|---|---|---|---|
| | of Color Particles | | resistance |
| Ink Composition 3 | 46 | nm | A |
| Ink Composition 4 | 74 | nm | B |
| Ink Composition 5 | 89 | nm | C |

From Table 1, it is understood that the scratch resistance of the recording image depends on the average particle diameter of the color particles, and that the scratch resistance is superior when the average particle diameter is 80 nm or less and is particularly superior when it is 50 nm or less.

The examples thus show that finely pulverized color particles capable of forming a high density recording image can be provided, according to aspects of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-200240 filed Aug. 31, 2009 and No. 2010-141943 filed Jun. 22, 2010, which are hereby incorporated by reference herein in their entirety.

What is claimed is:

1. Color particles comprising:
a dye; and
a polymer compound,
wherein the average particle diameter of the color particles measured by a dynamic light scattering method is 10 to 80 nm,
the content of the dye of the color particles is 60 to 90 percent by mass, and
the dye has a solubility index of 7.50 or more in water having a pH of 6.0 to 11.0, the solubility index being represented by the following equation (1):
Solubility Index=log(1/Aqueous Solubility of Dye [mol/L]). Equation (1)

2. The color particles according to claim 1,
wherein the average particle diameter of the color particles has a coefficient of variation of 60% or less.

3. The color particles according to claim 1,
wherein the color particles have an average aspect ratio in the range of 1.0 to 1.2.

4. An ink composition comprising the color particles according to claim 1.

5. A method for manufacturing color particles containing a dye and a polymer compound, comprising the steps of:
emulsifying water and a mixed liquid containing an organic solvent, a monomer, and a dye to obtain a miniemulsion which contains the mixed liquid in the form of dispersoids;
removing the organic solvent from the dispersoids; and
polymerizing the monomer after the removal step is performed,
wherein the dye has a solubility index of 7.50 or more in water having a pH of 6.0 to 11.0, the solubility index being represented by the following equation (1):
Solubility Index=log(1/Aqueous Solubility of Dye [mol/L]). Equation (1)
